(19) United States
(12) Patent Application Publication
(10) Pub. No.: US 2013/0220913 A1
(43) Pub. Date: Aug. 29, 2013

(54) FLUID FILTERS WITH MECHANICALLY COMPACTED FILTER BEDS COMPRISING GRANULAR FILTER MEDIA AND APPARATUSES AND METHODS RELATING THERETO

(71) Applicant: Ticona LLC, Florence, KY (US)

(72) Inventors: Joseph D. Cohen, Denver, CO (US); Christopher McGrady, Florence, KY (US); Dian Chen, Florence, KY (US); Bernard Jason Smith, Cincinnati, OH (US)

(73) Assignee: Ticona LLC, Florence, KY (US)

(21) Appl. No.: 13/773,848

(22) Filed: Feb. 22, 2013

Related U.S. Application Data
(60) Provisional application No. 61/634,040, filed on Feb. 23, 2012.

(51) Int. Cl. B01D 29/68

(52) U.S. Cl. CPC B01D 29/68
USPC 210/275; 210/333.01

(57) ABSTRACT

A fluid filter, with a media body that comprises granular filter media and is capable of transitioning from a compacted state to an expanded state, may allow for multiple filtration cycles with regeneration of the granular filter media via backwashing cycles. Two or more of such filters may also be used in filtration apparatuses that is configured for continuous filtration including during backwashing of one of the filters.

### CROSS-REFERENCE TO RELATED APPLICATIONS

This application claims the benefit of U.S. Provisional Application No. 61/634,040 filed on Feb. 23, 2012, the entire disclosure of which is incorporated herein by reference.

### BACKGROUND

The present invention relates to filters with mechanically compacted filter beds that comprise granular filter media, and apparatuses and methods relating thereto.

Fluid filtration apparatuses use filter beds that comprise filter media to filter impurities from an influent fluid (e.g., trap particulate matter and/or adsorb organic compounds). Filter beds can generally be classified into two types: sintered (or bonded) media or non-sintered (non-bonded) media. Bonded filter media is often particles fused together or fibrous woven or nonwoven material(s) that are bonded, but nonetheless have a given porosity to allow for flow therethrough. When the sintered filter media has a sufficient accumulation of impurities from an influent fluid, the filter bed (often in a filter cartridge) is removed from the filtration apparatus and replaced. In some instances, the filter bed can be cleaned using a secondary apparatus (e.g., via backwashing with chemicals like acidic cleaning solutions) and reinstalled.

During these filter exchange periods, the filtration apparatus needs to be taken offline to replace the filter cartridge, which often requires not just removing the cartridge, but also dismantling, draining pipes and valves, then reassembling a filtration apparatus. This takes time, tools, and know-how and presents potential problems in terms of undesirable leaking, flooding, and water contamination from improper installation. Accordingly, a need exists for filtration apparatuses that can be cleaned while in situ still allowing for clean, filtered fluids to be produced.

Non-sintered filter media, on the other hand, is often granular matter (e.g., sand or diatomaceous earth) where the porosity is derived from the packing configuration of the granules and the spacing between the non-bonded filter media. When the non-sintered filter media has a sufficient accumulation of impurities from an influent fluid, a backwash fluid can be flowed in the opposite direction of the influent fluid, thereby fluidizing the non-sintered filter media, and consequently separating the non-sintered media from the trapped impurities (e.g., dislodging particles trapped therein and/or cleaning the organic matter adsorbed to the surface of the non-sintered filter media). The resultant backwash fluid having the contaminants can be directed to a waste system, and the fluid flow and filtration apparatus is returned to a filtration setup.

However, as a consequence of the filter media being non-bonded, the filter media can shift, which often leads to cracks in the filter bed. These cracks allow for contaminants to pass through the filter. Cracks in the filter media are more prevalent as particle size decreases, which corresponds to smaller pore sizes. Accordingly, a need exists for efficient small particle filtration using non-bonded media.

### SUMMARY OF THE INVENTION

The present invention relates to filters with mechanically compacted filter beds that comprise granular filter media, and apparatuses and methods relating thereto.

In some embodiments, a filtration apparatus may include a filtration apparatus inlet; a filtration apparatus outlet; first and second filters each being independently movable between a filtration configuration and a backwash configuration and each comprising: a filter inlet, a filter outlet, a backwash inlet, a backwash outlet, and a media body that comprises a top and a bottom and containing a granular filter media, the media body being movable between a compacted state in the filtration configuration and an expanded state in the backwash configuration, the media body being disposed between the filter inlet and the filter outlet, and the media body being disposed between the backwash inlet and the backwash outlet; a valve apparatus being movable between at least three positions that comprise: a dual filtration position that provides for the first filter in the filtration configuration and the second filter in the filtration configuration with the filtration inlet being in fluid communication with the first filter inlet and the second filter inlet, and the filtration apparatus outlet being in fluid communication with the first filter outlet and the second filter outlet, a first filter backwash position that provides for the first filter in the backwash configuration and the second filter in the filtration configuration with the filtration inlet being in fluid communication with the second filter inlet, and the second filter outlet being in fluid communication with the first backwash inlet and the filtration apparatus outlet, and a second filter backwash position that provides for the first filter in the filtration configuration and the second filter in the backwash configuration with the filtration inlet being in fluid communication with the first filter inlet, and the first filter outlet being in fluid communication with the second backwash inlet and the filtration apparatus outlet.

In some embodiments, a filter having a filtration configuration and a backwash configuration may include a housing; a filter inlet; a filter outlet; a backwash inlet; a media body that comprises a top and a bottom and containing a granular filter media, the media body being movable between a compacted state in the filtration configuration and an expanded state in the backwash configuration, the media body being disposed between the filter inlet and the filter outlet, and the media body being disposed between the backwash inlet and the backwash outlet; and at least one port configured to provide for flow fluid at an angle deviated from a filtration flow direction and a backwash flow direction, the filtration flow direction being from the filter inlet through the media body to the filter outlet, and the backwash flow direction being from the backwash inlet through the media body to the backwash outlet.

In some embodiments, a filter having a filtration configuration and a backwash configuration may include a housing; a filter inlet; a filter outlet; a backwash inlet; a backwash outlet; a media body that comprises a top and a bottom and containing a granular filter media, the media body being movable between a compacted state in the filtration configuration and an expanded state in the backwash configuration, the media body being disposed between the filter inlet and the filter outlet, and the media body being disposed between the backwash inlet and the backwash outlet; and wherein the top and the bottom independently have a substructure to provide for a variable depth filter bed comprising the granular filter media when the media body is in the compacted state.

In some embodiments, a filter having a filtration configuration and a backwash configuration may include a housing; a filter inlet; a filter outlet; a backwash inlet; a backwash outlet; a media body that comprises a top and a bottom and containing a granular filter media, the media body being movable between a compacted state in the filtration configuration and an expanded state in the backwash configuration, the media body being disposed between the filter inlet and the filter outlet, and the media body being disposed between the backwash inlet and the backwash outlet; and wherein at least one of the first and second tops have a hemi-orbicular shape.

In some embodiments, a method may involve providing a filtration apparatus that comprises a first and a second filter each independently having a filtration configuration and a backwash configuration, the filtration apparatus further comprising a valve apparatus being movable between at least three positions that comprise: a dual filtration position that provides for the first filter in the filtration configuration and the second filter in the filtration configuration, a first filter backwash position that provides for the first filter in the backwash configuration and the second filter in the filtration configuration, and a second filter backwash position that provides for the first filter in the filtration configuration and the second filter in the backwash configuration; and filtering a fluid through the filtration apparatus.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIGS. 1A-C provide illustrative diagrams of filters described herein.

FIG. 2 provides an illustrative diagram of a filter described herein.

FIG. 3 provides an illustrative diagram of a filter described herein.

FIGS. 4A-B provide illustrative diagrams of a top of a media body described herein.

FIG. 5 provides an illustrative diagram of a top of a media body described herein.

FIG. 6 provides an illustrative diagram of a variable depth filter bed described herein.

FIGS. 7A-B provide illustrative diagrams of a filter having a variable depth filter bed described herein.

FIG. 8 provides an illustrative diagram of a filter described herein.

FIGS. 9A-D provide illustrative diagrams of filtration apparatuses described herein.

FIGS. 10A-C provide illustrative diagrams of a filtration apparatus described herein in three configurations.

FIG. 11 provides a scanning electron micrograph of an example of potato-shaped granular filter media described herein.

FIG. 12 provides a scanning electron micrograph of an example of popcorn-shaped granular filter media described herein.

### DETAILED DESCRIPTION

The present invention relates to filters with mechanically compacted filter beds that comprise granular filter media, and apparatuses and methods relating thereto.

The filters described herein utilize granular filter media in a compacted state to remove fluid contaminants and are designed to allow for fluidization of the granular filter media to remove and clean the contaminants from the granular filter media. Compaction of the granular filter media into a filter bed contained within the media body during filtration mitigates shifting of granular filter media that often leads to cracks in the filter bed that can form during abrupt changes to the flow rate (e.g., turning filters on, changing flow rates, and the like). Additionally, the compaction of the granular filter media into a filter bed allows for the filters to function in any position (e.g., including upside down or in weightless environments) and in areas with vibration that would otherwise cause cracks in a filter bed.

Further, the filters described herein may optionally have additional features including media body components having substructures and fluid ports to enhance filtration and/or backwashing efficiency. As described in more detail herein, filter components having substructures, e.g., pleated structures, may provide for enhanced recompaction of the granular filter media after a backwash cycle and mitigate filter cake buildup on the top of the media body. Further, the substructure may increase the surface area of the filter bed, thereby allowing for increased flow rates and increased filtration efficacy. Additional fluid ports provide for directing fluid flow that can be used for mitigating filter cake buildup on the top of the media body, enhancing removal of the filter cake from the top of the media body during backwashing, enhancing fluidization of the granular filter media during backwashing, and mitigating clogging of the fluid ports responsible for the primary direction of fluid flow.

Further, the choice of granular filter media in combination with the filter design may allow for filters (or filter apparatuses) to be shipped that are ready to be implemented without needing to disassemble to insert the filter media, which is the case in some backwash filters.

Additionally, the filtration apparatuses described herein may include two or more filters and be designed to allow for the continuous production of filtered fluid, including allowing for simultaneous backwashing of at least one filter while filtering with at least one other filter. Such filtration apparatuses may advantageously mitigate filtration downtime and allow for quick exchange of individual filters.

As used herein, the term “granular filter media” refers to non-sintered granules (i.e., granules that are not bound) that may be of any desired size, shape, and aspect ratio so as to provide for desired filtration properties and encompasses filter media that comprise more than one type of granule. Examples of granular filter media are described herein.

It should be noted that when “about” is provided herein in reference to a number in a numerical list, the term “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

### I. Filters

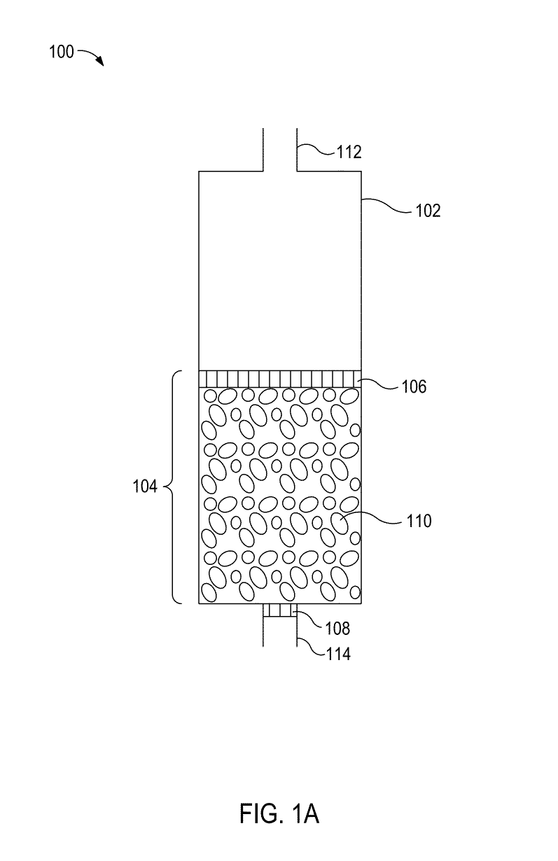

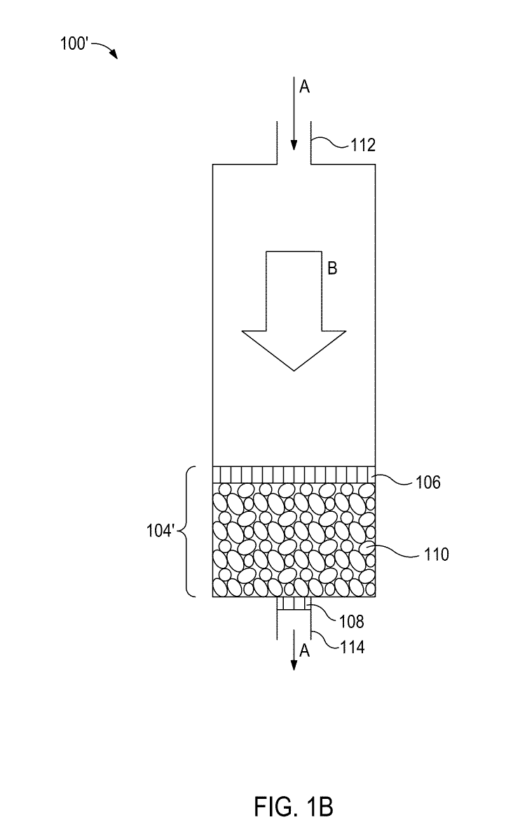

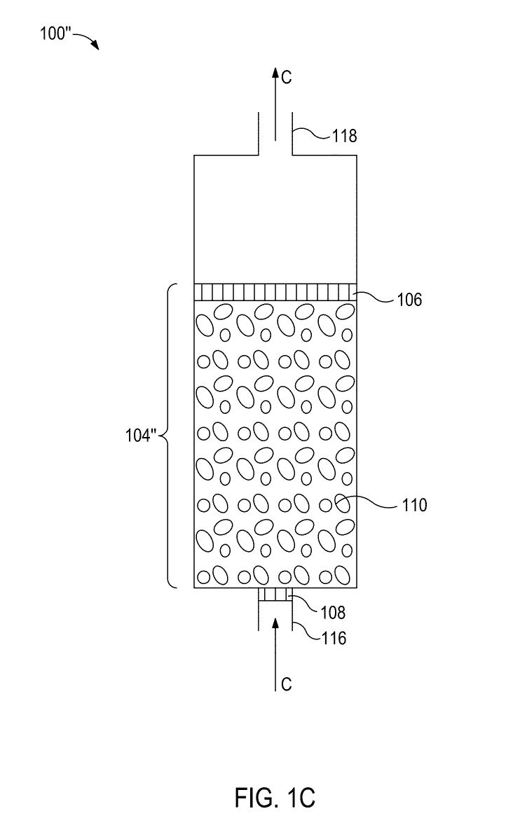

Referring now to the nonlimiting illustration in FIG. 1A, in some embodiments, the filters 100 described herein comprise housing 102, at least two ports 112,114, and media body 104 disposed between the two ports 112,114. Media body 104 comprises top 106 and bottom 108, wherein at least one port 112 is proximal to top 106 and at least one port 114 is proximal to bottom 108. Granular filter media 110 is contained within media body 104. Media body 104 is configured to change internal volume so as to allow for at least two configurations including a filtration configuration 100′ where media body 104′ is in a compacted state (illustrated in FIG. 1B) and a backwash configuration 100″ (illustrated in FIG. 1C) where media body 104″ is in an expanded state.

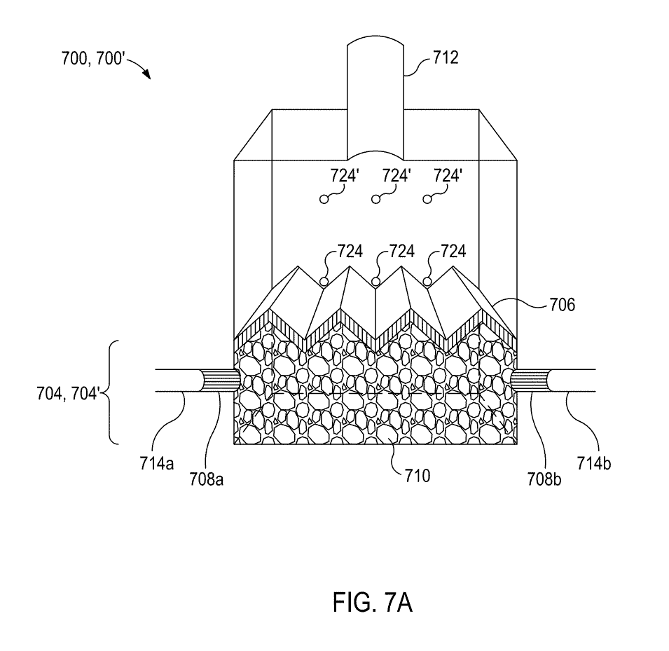

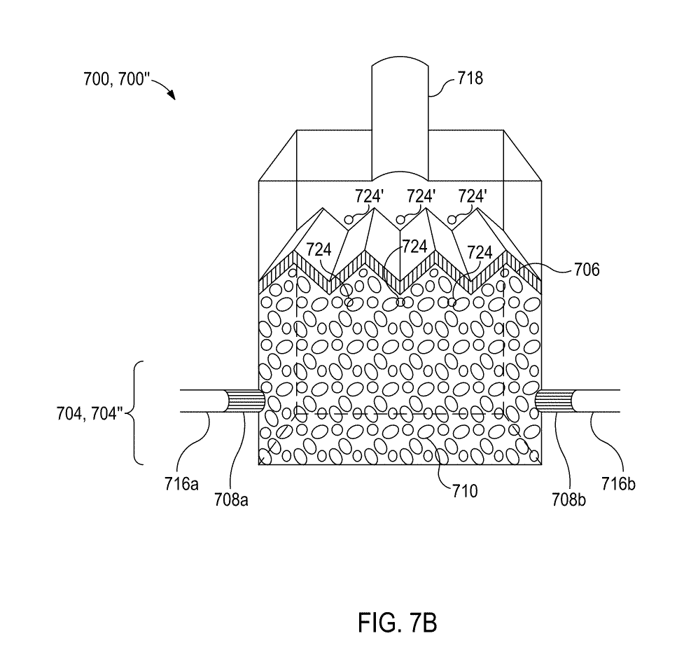

It should be noted that the terms “top” and “bottom” do not imply or define a relationship of the filter to any given plane (e.g., the ground). Rather, as used herein, the terms “top” and “bottom” refer to the permeable, solid portions (e.g., screens, slotted plates, perforated plates, and the like) of the media body that a fluid will pass through before and after passing through the granular filter media, respectively, when the filter is in the filtration configuration. In some embodiments, the top and bottom may be nonparallel, e.g., as shown in FIG. 7, which is described in more detail herein.

Referring now to the nonlimiting illustration in FIG. 1B, in filtration configuration 100′, top 106 and bottom 108 are positioned to yield compacted media body 104′ wherein granular filter media 110 is compacted into a substantially immovable position referred to herein as a filter bed. In the filtration configuration 100′, compacted media body 104′ is compacted by force B. Fluid flows in direction A along filtration flow path through filter inlet 112, top 106, compacted media body 104′, bottom 108, and then filter outlet 114, so as to collect a plurality of contaminants in the fluid passing through compacted media body 104′.

Referring now to the nonlimiting illustration in FIG. 1C, in backwash configuration 100″, force B is reduced allowing for positioning of top 106 and bottom 108 to yield expanded media body 104″ wherein granular filter media 110 fluidizes. Fluid flows in direction C along backwash flow path through backwash inlet 116, bottom 108, expanded media body 104″, top 106, and then backwash outlet 118, so as to dislodge and remove at least some of the contaminants from granular filter media 110. As used herein, the term “fluidize” refers to the granular filter media being in a dynamic fluid-like state where media grains or small aggregates thereof can move independently. It should be noted that depending on the filter configuration and flow rates, a portion of the granular filter media may remain aggregated even thought the media is fluidized.

The force that is applied to achieve a compacted media body may be achieved with, for example, at least one of sufficient fluid pressure from the filter inlet, an elastic device (e.g., a spring, a sponge foam, or a rubber cement), a non-elastic device moved between various positions (e.g., a pushrod, a ratcheted rod, an electric motor, an electric solenoid, a hydraulic cylinder, or a thermal motor), and the like, any hybrid thereof, and any combination thereof. In some embodiments, it should be noted that the force may be applied by pushing and/or pulling the top and/or the bottom so as to converge the top and the bottom into a compacted media body.

Reducing the force to allow for an expanded media body may be achieved by, for example, reducing or eliminating the force (e.g., changing the direction of the fluid pressure to be from the outlet or moving the non-elastic device to another position), applying a second, larger force in the opposite direction (e.g., applying fluid pressure from the outlet sufficient to compress an elastic device), and the like, any hybrid thereof, and any combination thereof. Again, this may be achieved by pushing and/or pulling the top and/or the bottom to diverge the top and the bottom into an expanded media body. In some embodiments, the media body may be expanded to a volume increase that depends on the forces applied/reduced and may vary between backwash cycles. In some embodiments, the media body may be expanded to a preset volume increase.

In some embodiments, the internal volume of the media body may be configured to increase from the filtration configuration to the backwash configuration by an amount ranging from a lower limit of about 25%, 30%, 40%, or 50% to an upper limit of about 100%, 75%, or 50%, and wherein the amount may range from any lower limit to any upper limit and encompasses any subset therebetween. One of ordinary skill in the art should realize that the increase in internal volume may be dependent on, inter alia, the configuration of the filter, the forces applied/reduced between the filtration and backwash configurations. Further, it has been contemplated that higher volume increases are possible but, in some embodiments, not preferable as increasing the internal volume often increases the amount of water and time needed to clean the granular filter media.

In some embodiments, a filter bed in the filtration configuration may have a depth of about 1 mm (0.039 in) or greater. For example, a filter bed in the filtration configuration may have a depth ranging from a lower limit of about 1 mm (0.039 in), 5 mm (0.20 in), 25 mm (0.98 in), or 100 mm (3.9 in) to an upper limit of about 5 m (197 in), 1 m (39 in), 50 cm (20 in), or 25 cm (9.8 in), and wherein the depth may range from any lower limit to any upper limit and encompasses any subset therebetween. It should be understood by one of ordinary skill in the art that the filter bed depth in the filtration configuration may depend upon, inter alia, the configuration and size of the filter and may, in some embodiments, be outside the ranges described herein.

In some embodiments, the filter inlet may be the backflush outlet and the filter outlet may be the backflush inlet (e.g., as shown by comparing FIGS. 1B and 1C). In some embodiments, a filter may comprise a filter inlet, a filter outlet, a backwash inlet, and a backwash outlet that is the filter inlet. In some embodiments, a filter may comprise a filter inlet, a filter outlet, a backwash inlet that is the filter outlet, and a backwash outlet. In some embodiments, a filter may comprise a filter inlet, a filter outlet, a backwash inlet, and a backwash outlet that are independently different ports.

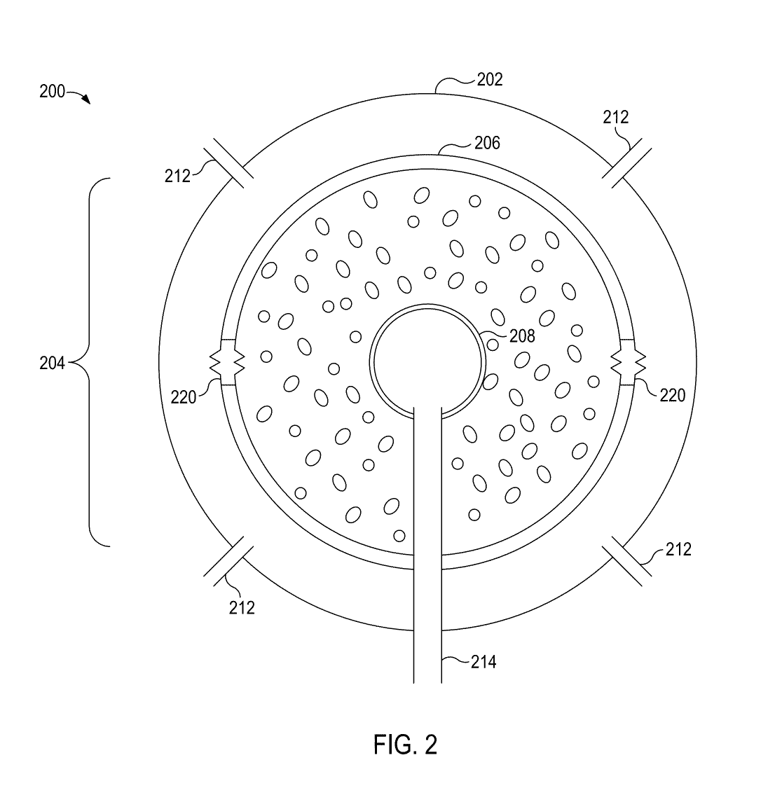

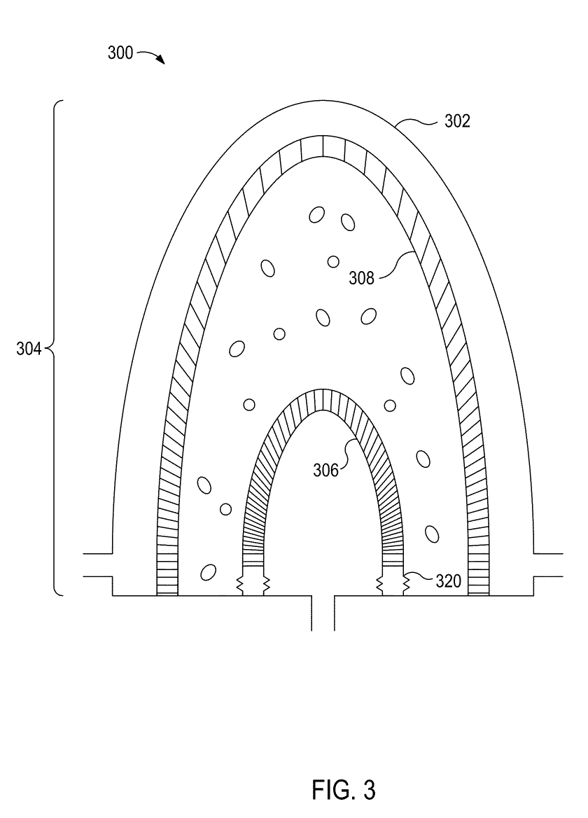

While FIGS. 1A-C illustrate the filter in a cylindrical configuration, these are exemplary only and other configurations may be used to achieve such a filtration mechanism (i.e., compacted granular filter media during filtration and fluidized granular filter media during backwash). For example, FIG. 2 illustrates filter 200 with an orbicular media body 204 with an orbicular top 206 and a spherical bottom 208. Top 206, as illustrated, has bellows 220 that allow for top 206 to expand (i.e., at least a portion of the top 206 diverge from the bottom 308), thereby allowing for the granular filter media to fluidize in a backwash configuration. Further, filter 200 includes ports 212 (e.g., a filter inlet and/or a backwash outlet) in housing 202 and port 214 (e.g., a filter outlet and/or a backwash inlet) proximal to bottom 208. In another example, FIG. 3 illustrates filter 300 with a dome or hemi-orbicular media body 304 that comprises a hemi-orbicular top 306 and a hemi-orbicular bottom 308. As illustrated, top 306 has bellows 320 that allow for top 306 to expand (i.e., diverge from the bottom 308), thereby allowing for the granular filter media to fluidize in a backwash configuration. In some embodiments, other mechanisms that provide a seal while allowing for movement of the top and/or the bottom may include, but are not limited to, bellows, movable seals, and the like.

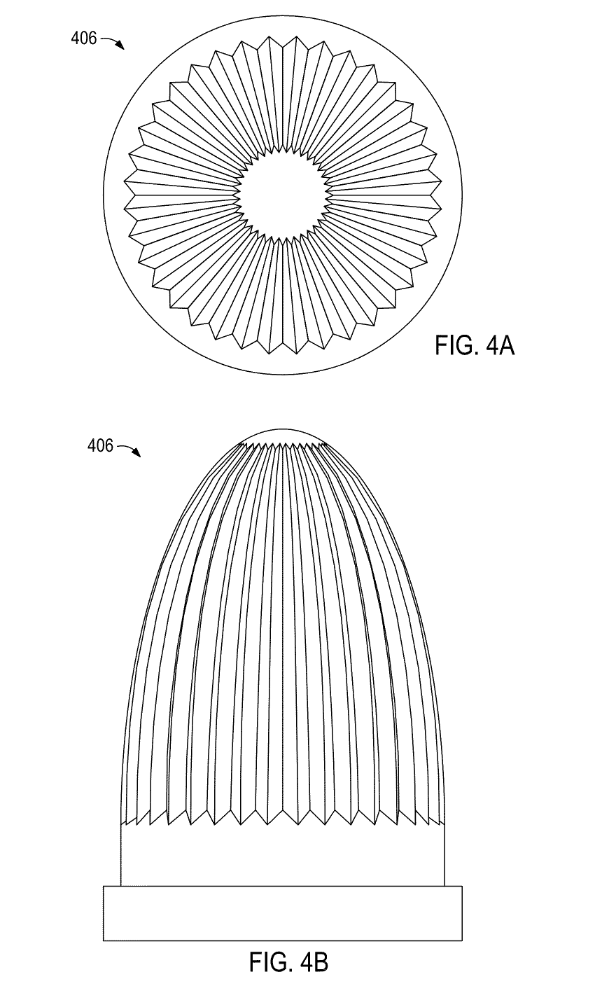

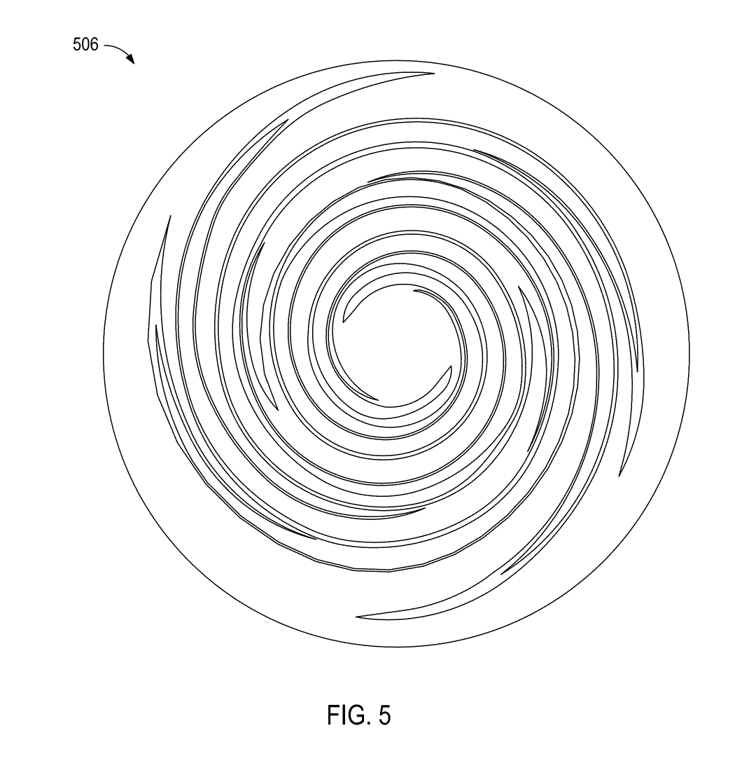

In some embodiments, the media body may have a substructure at the top, the bottom, or both. As used herein, the term “substructure” refers to a feature of a structure that do not contribute to the general shape of the structure. For example, FIGS. 4A-B illustrate a top-view and a side-view, respectively, of a hemi-orbicular top 406 having a pleated substructure. Examples of substructure may include, but are not limited to, pleats, grooves, ripples, cones (e.g., like spikes), and the like, any hybrid thereof, and any combination thereof. In some embodiments, a substructure may be a biplaner netting (e.g., a screen or netting having high permeability disposed on the top and/or the bottom having lower permeability). In some embodiments, a substructure may have a repeating pattern (e.g., the pleating in FIGS. 4A-B), a designed pattern (e.g., a grooved swirl of top 506 illustrated in FIG. 5), and the like, any hybrid thereof, and any combination thereof.

Without being limited by theory, it is believed that if the top has a substructure filtration efficiency may increase because of the increased surface area of the media body, and consequently of the filter bed, allowing for higher fluid flow rates. Further, it is believed that a top having a substructure may increase the length of time between backwash cycles by mitigating filter cake formation. It is believed that depressed portions of the substructure allow for accumulations of larger particles that cannot traverse the top. Accumulation of the larger particles in depressions may minimize filter cake formation on the raised portions of the substructure allowing for filtration therethrough over an extended period of time.

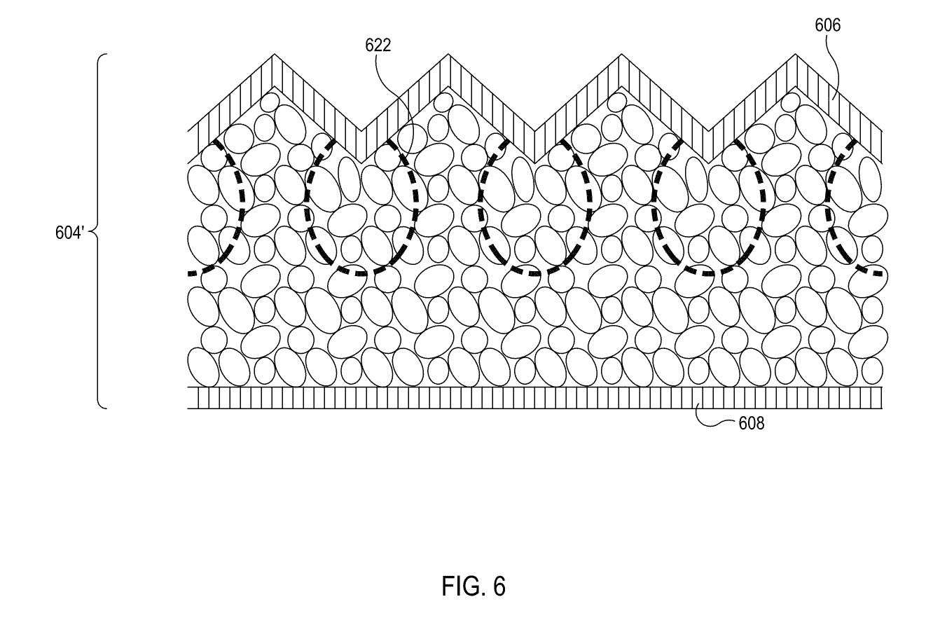

In some embodiments, the media body may be designed to yield a filter bed having a variable bed depth (also referred to herein as a variable depth filter bed), for example, as illustrated in FIG. 6 at compacted media body 604″ comprising top 606 and bottom 608. Without being limited by theory, it is believed that a variable bed depth may provide for fluid to initially flow primarily through the narrower bed depth areas (i.e., the path of least resistance), thereby preferentially accumulating contaminants 622 within the filter bed in the narrower filter bed areas. Then, as the narrower bed depth areas become saturated with contamination, the longer bed depth areas become the path of least resistance and fluid flow will modulate thereto. Such fluid flow dynamics may provide for an increased length of time between backwash cycles.

In some embodiments, the top and the bottom may each have corresponding substructures that yield a filter bed having a consistent filter bed depth.

In some embodiments, the substructure of media body components (e.g., the top, the bottom, any portion of the housing that defines the media body, and the like) may be designed to enhance the packing efficiency of the granular filter media as the filter transitions from a backwash configuration to a filtration configuration. For example, a top having a pleated substructure (e.g., as shown in FIG. 6) or the like may advantageously act like a plow to push the granular filter media into a higher packing efficiency configuration as compared to a top having no substructure. Further, a bottom may have a corresponding pleated structure (not shown) or the like that allows for the granular filter media to settle within the depressed portions as the filter transitions from a backwash configuration to a filtration configuration.

In some embodiments, the filter may comprise additional ports (fluid inlets and outlets) for a variety of purposes, e.g., having separate inlets and outlets for filtration and backwash (i.e., filter inlet and backwash outlet physically being different ports), mitigating filter cake formation on the top during filtration, enhancing filter cake removal from the top during backwash, enhancing fluidization of the granular filter media during backwash, enhancing flow of contaminants to an outlet, and the like, and any combination thereof. Such additional ports may be configured to provide fluid flow at an angle deviated from general fluid flow direction.

Referring now to the nonlimiting illustrations of FIG. 7A-B, filter 700 may comprise filter inlet 712, two filter outlets 714a,b, two backwash inlets 716a,b, backwash outlet 718, ports 724, ports 724′, and media body 704 that comprises top 706, two bottoms 708a,b, and granular filter media 710. Ports 724 are configured to provide for introducing flow tangential to top 706 while filter 700 is in filtration configuration 700′ with compacted media body 704′, which as illustrated are located so as to provide tangential flow in the depressed portions of a pleated top. Ports 724′ are configured to provide for introducing flow tangential to top 706 while filter 700 is in backwash configuration 700″ with expanded media body 704″, which, as illustrated, are located so as to provide tangential flow in the depressed portions of a pleated top.

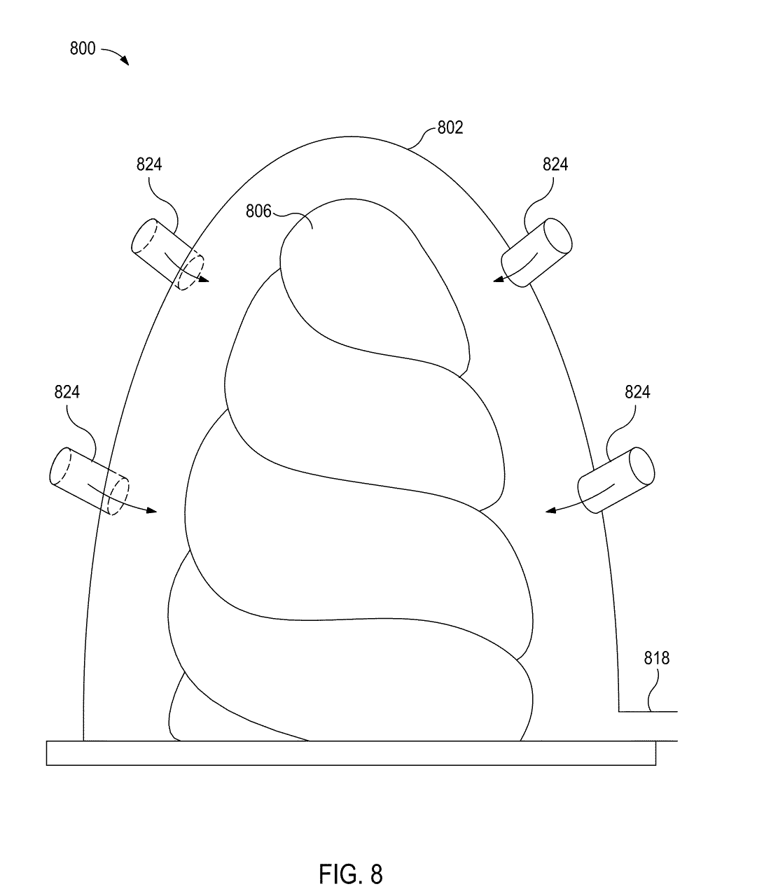

Referring now to the nonlimiting illustrations of FIG. 8, filter 800 may comprise hemi-orbicular top 806 having a coiled substructure (e.g., appearing to be similar in shape to a rope coiled into a hemi-orbicular) and housing 802 with ports 824 configured to inject fluid at an angle that provides for circular flow (e.g., vortex or vortex-like flow) about the hemi-orbicular top 806 and in a generally downward angle to provide for direction fluid during a backwash to backwash outlet 818.

In some embodiments, a filter may comprise at least one port configured to provide for flow fluid at an angle deviated from the filtration flow direction (i.e., the flow direction of the filter inlet to the media body to the filter outlet) while the first filter is in the filtration configuration. In some embodiments, a filter may comprise at least one port configured to provide for flow fluid at an angle deviated from the backwash flow direction (i.e., the flow direction of the backwash inlet to the media body to the backwash outlet) while the first filter is in the backwash configuration. It should be noted that a flow direction may be non-straight. As such, an angle deviated from a flow direction refers to a deviation from the flow direction where the additional fluid flow is being introduced.

In some embodiments, a filter may comprise at least one port configured to provide for flow fluid tangential to the top while in the filtration configuration. In some embodiments, a filter may comprise at least one port configured to provide for flow fluid tangential to the top while in the backwash configuration. In some embodiments, a filter may comprise at least one port configured to provide for flow fluid tangential to the bottom while in the backwash configuration.

In some embodiments, the ports configured to flow fluid at an angle deviated from the filtration flow direction and/or the backwash flow direction may be configured independently to flow fluid at a velocity less than, equal to, or greater than the flow rate in the filtration flow direction and/or the backwash flow direction. For example, a port may be configured to act as a high-velocity jet. Such a high-velocity jet may be especially useful in configurations that assist with mitigating filter cake buildup, with breaking-up a filter cake that has formed, with fluidizing the granular filter media proximal to the top and/or bottom, and the like. In some embodiments, the ports described herein that are tangential to the top and/or the bottom in any configuration of the filter may be high-velocity jets.

In some embodiments, a filter may comprise at least one port configured to provide for flow fluid that directs fluid flow to an outlet. For example, a media body may comprise an inlet and outlet that are functional after backwashing is complete but before the granular filter media is compacted into a filter bed. In some embodiments, after the flow in the housing becomes less turbid, or even substantially stagnant, the heavier particulates captured by the filter bed may settle due to gravity, while buoyant granular filter media floats, and the foregoing inlet and outlet may be utilized to collect the particulates that settle (i.e., the inlet provide for fluid flow in the direction of the outlet).

One of ordinary skill in the art with the benefit of this disclosure should recognize the plurality of configurational variants that allow for the same filtration mechanism.

Filtration methods utilizing filters described herein may involve filtering a first fluid through a media body in a compacted configuration; and backwashing a second fluid through the media body in an expanded configuration. In some embodiments, the second fluid may comprise at least a portion of the first fluid having passed through the media body. In some embodiments, the steps of filtering and backwashing may be performed multiple times in series, e.g., performing each at least 2 times, 3 times, 5 times, 10 times, hundreds of times, and so on over the life of the granular filter media, including potentially thousands of times. In some embodiments, the cycling of the steps of filtering and backwashing may be continuous, intermittent, and any combination thereof.

In some embodiments, a fluid (e.g., a filtration fluid or a backwashing fluid) may be passed through the media body comprising a filter bed or fluidized granular filter media, respectively, at a flow rate ranging from a lower limit of about 0.2 gallon per minute (“GPM”) (0.045 m³/hr), 0.5 GPM (0.11 m³/hr), 1 GPM (0.23 m³/hr), 5 GPM (1.1 m³/hr), 25 GPM (5.7 m³/hr), or 50 GPM (11 m³/hr) to an upper limit of about 200 GPM (45 m³/hr), 150 GPM (34 m³/hr), 100 GPM (23 m³/hr), or 50 GPM (11 m³/hr), and wherein the flow rate may range from any lower limit to any upper limit and encompasses any subset therebetween.

One of ordinary skill in the art with the benefit of this disclosure should understand that the influent fluid and/or the backwashing fluid flow rates may depend on, inter alia, the filter bed depth (e.g., thinner bed depths may provide for higher flow rates and thicker bed depths may provide for lower flow rates), the composition of the granular filter media, the configuration of the filter including the diameter of the inlets and outlets, and the like, and any combination thereof. Accordingly, the influent fluid and/or the backwashing fluid flow rates may be outside the ranges described in this disclosure.

### II. Filtration Apparatuses

In some embodiments, a filtration apparatus may utilize two or more filters described herein in series, and parallel, or a combination thereof.

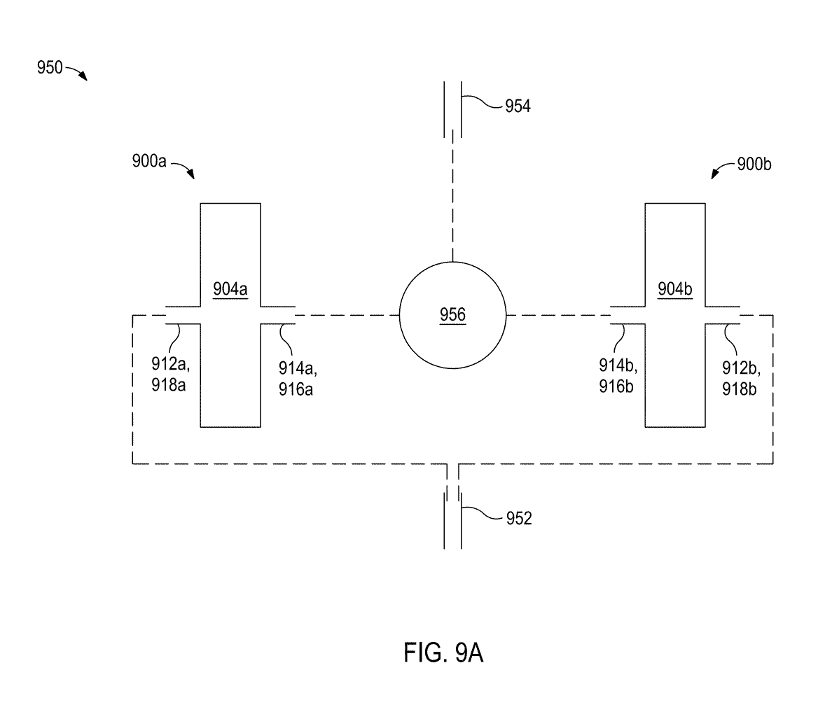

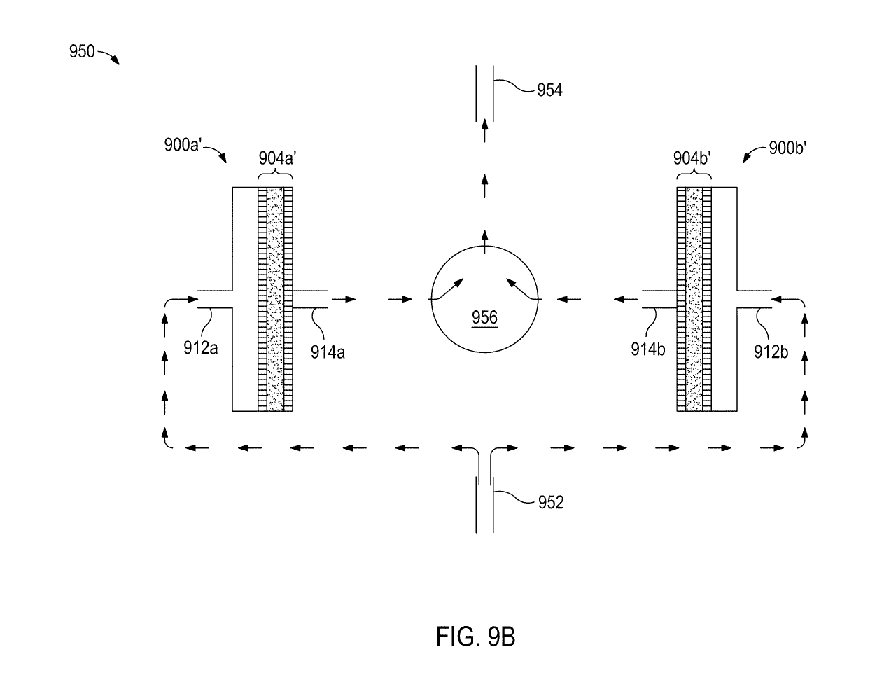

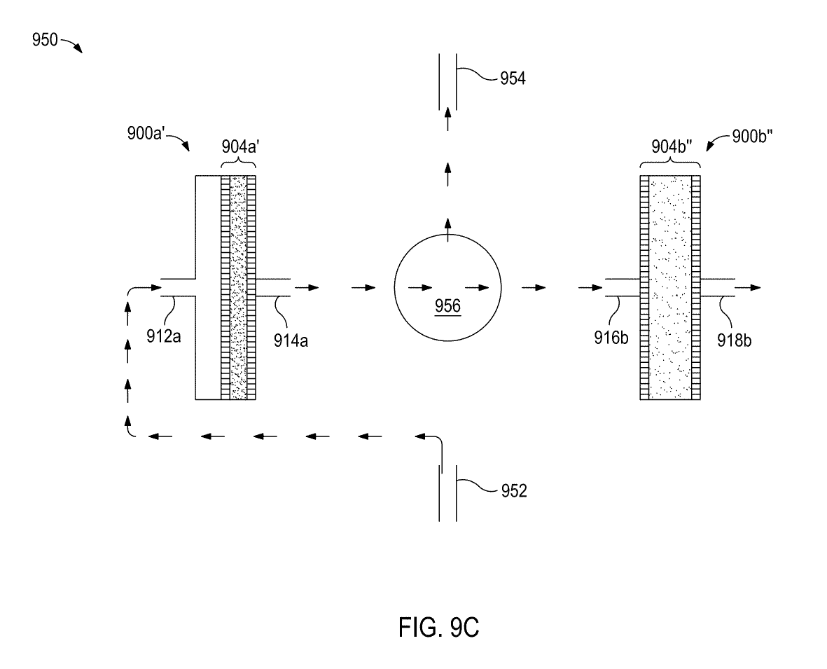

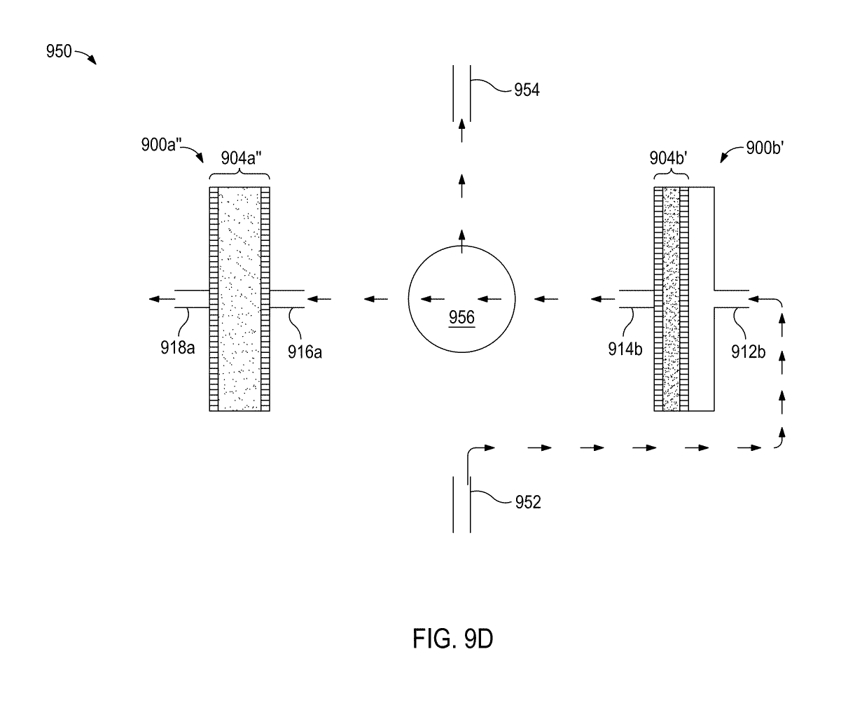

Referring to the nonlimiting diagram in FIG. 9A with dashed lines to indicate fluid communication, filtration apparatus 950 includes filtration apparatus inlet 952, filtration apparatus outlet 954, first and second filters 900a,900b, and valve apparatus 956. Each of the first and second filters include filter inlet 912a,912b, filter outlet 914a,914b, backwash inlet 916a,916b, backwash outlet 918a,918b, and media body 904a,904b. As described above but not shown, in some embodiments, filter inlet 912a,912b and backwash outlet 918a,918b may physically be different ports, and filter outlet 914a,914b and backwash inlet 916a,916b may physically be different ports.

Each filter 900a,900b has at least two configurations including a filtration configuration and a backwash configuration, thereby providing for at least three configurations for filtration apparatus 950: (1) a dual filtration position with first filter in filtration configuration 900a′ and second filter in filtration configuration 900b′ (FIG. 9B), (2) second filter backwash position with first filter in filtration configuration 900a′ and second filter in backwash configuration 900b″ (FIG. 9C), and (3) first filter backwash position with first filter in backwash configuration 900a″ and second filter in filtration configuration 900b′ (FIG. 9D).

Referring now to FIG. 9B, filtration apparatus 950, in a dual filtration position, comprises filtration apparatus inlet 952, filtration apparatus outlet 954, first and second filters in filtration configuration 900a′,900b′, and valve apparatus 956. Each of the first and second filters, in a filtration configuration, comprise filter inlet 912a,912b, filter outlet 914a,914b, and media body in a filtration configuration 904a′,904b′ that comprises granular filter media in a compacted state, as described above. Filtration apparatus 950 in a dual filtration position provides for fluid flow from the filter outlet 914a,914b of each filter to proceed to filtration apparatus outlet 954.

Referring now to FIG. 9C, filtration apparatus 950, in a second backwash position, comprises filtration apparatus inlet 952, filtration apparatus outlet 954, first filter in filtration configuration 900a′, second filter in backwash configuration 900b″, and valve apparatus 956. The first filter, in a filtration configuration, comprise first filter inlet 912a, first filter outlet 914a, and first media body in a filtration configuration 904a′ that comprises granular filter media in a compacted state, as described above. The second filter, in a backwash configuration, comprise second backwash inlet 916b, second backwash outlet 918b, and second media body in a backwash configuration 904b″ that comprises granular filter media in a fluidized state, as described above. Filtration apparatus 950 in a second backwash position provides for fluid flow from the first filter outlet 914a to proceed to both filtration apparatus outlet 954 and second backwash fluid inlet 916b.

Referring now to FIG. 9D, filtration apparatus 950, in a second backwash position, comprises filtration apparatus inlet 952, filtration apparatus outlet 954, first filter in filtration configuration 900a′, second filter in backwash configuration 900b″, and valve apparatus 956. The first filter, in a backwash configuration, comprise first backwash inlet 916a, first backwash outlet 918a, and first media body in a backwash configuration 904a″ that comprises granular filter media in a fluidized state, as described above. The second filter, in a filtration configuration, comprise second filter inlet 912b, second filter outlet 914b, and second media body in a filtration configuration 904b′ that comprises granular filter media in a compacted state, as described above. Filtration apparatus 950, in a first backwash position, provides for fluid flow from the second filter outlet 914b to proceed to both filtration apparatus outlet 954 and first backwash fluid inlet 916a.

In some embodiments, a filtration apparatus may comprise a filtration apparatus inlet; a filtration apparatus outlet; first and second filters that each have a filtration configuration and a backwash configuration; and a valve apparatus having at least three positions that comprise: a dual filtration position that provides for the first filtration configuration and the second filtration configuration, a first filter backwash position that provides for the first backwash configuration and the second filtration configuration, and a second filter backwash position allowing for the first filtration configuration and the second backwash configuration. The filtration configuration may provide for a filtration flow path that comprises, in order, the filtration apparatus inlet, the filter inlet, the media body comprising the granular filter media in a compacted state, the filter outlet, and the filtration apparatus outlet. The backwash configuration may provide for a backwash flow path that comprises, in order, the backwash inlet, the media body comprising the granular filter media in a fluidized state, and the filter backwash outlet, wherein the fluid to the backwash inlet is provided from another filter's filter outlet in the filtration apparatus.

The valve apparatus described herein may provide for fluid flow control at a plurality of locations in the filtration apparatus, e.g., diverting the fluid flow at the filtration apparatus inlet, diverting the fluid flow between individual filters, allowing or preventing fluid flow through filtration inlets and outlets for individual filters, allowing or preventing fluid flow through backflush inlets and outlets for individual filters, directing the fluid after backwashing to a waste stream or container, allowing or preventing fluid flow through additional ports for individual filters, and the like and any combination thereof.

The valve apparatus may, in some embodiments, be spring-loaded, or the like, to provide for a normal position of dual filtration and other positions to require continued pressure on the valve position (i.e., holding in another desired position), such that when the pressure is release the valve is returned to the normal position.

As described above, each filter may independently have additional features, e.g., a media body component having a substructure, additional ports, a filter component for applying a force to transition the media body between a compacted configuration and fluidized configuration (e.g., a push rod, a spring, and the like), and the like.

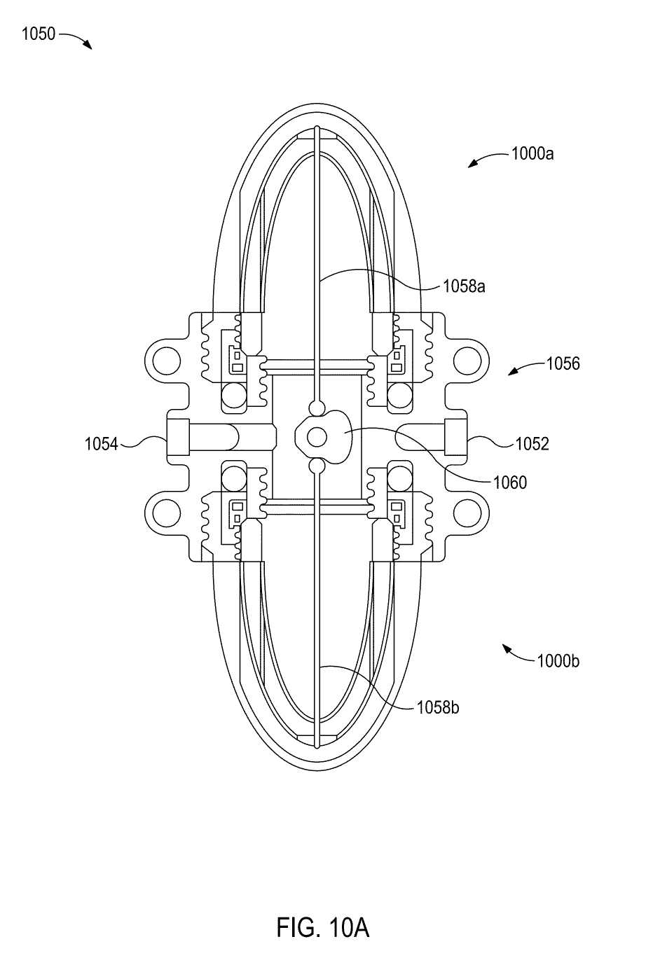

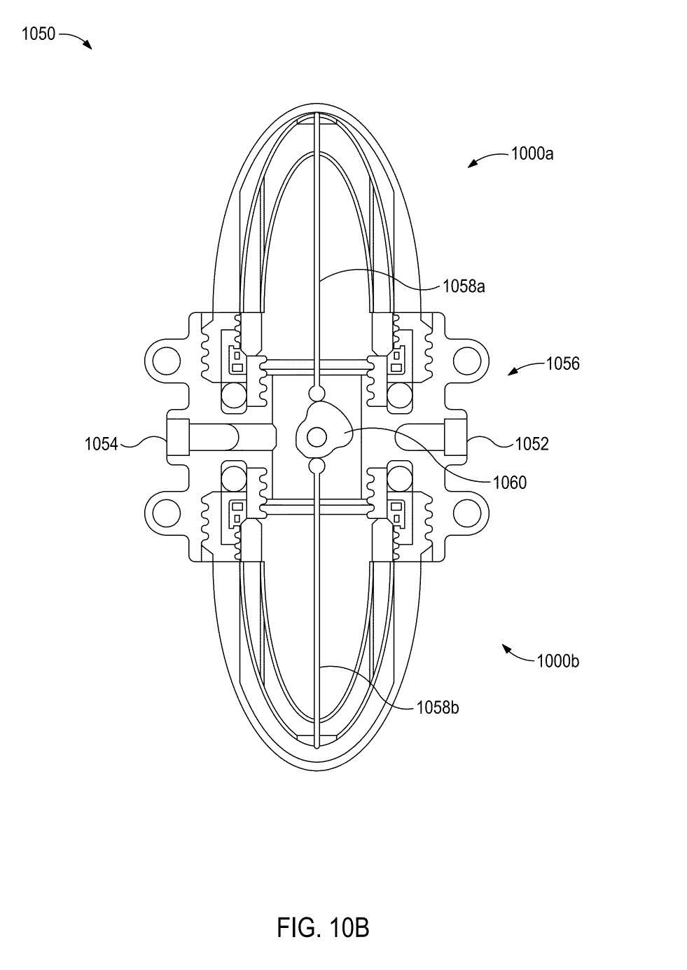

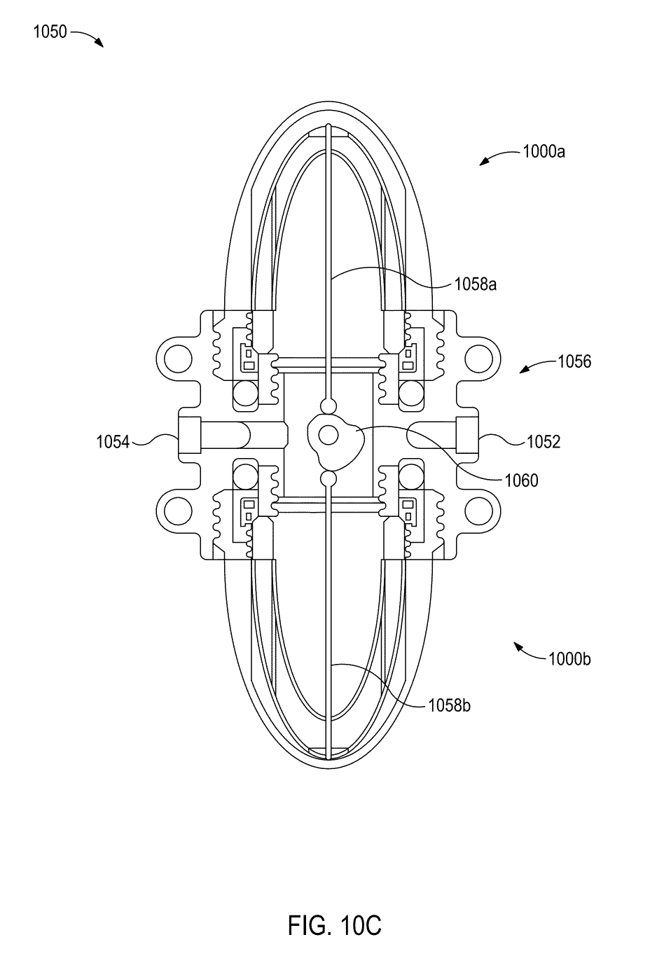

For example, FIG. 10A-C illustrates filtration apparatus 1050 that comprises filtration apparatus inlet 1052, filtration apparatus outlet 1054, two filters 1000a,1000b, and valve apparatus 1056. As shown, valve apparatus 1056 comprises pushrods 1058a,1058b and cam 1060 for transitioning filters 1000a,1000b between the filtration configuration and the backwash configuration to allow for three configurations of filtration apparatus 1050: a dual filtration position (FIG. 10A), a first filter backwash position (FIG. 10B), and a second filter backwash position (FIG. 10C). Further, valve apparatus 1056 may comprise a fluid direction system (not shown) to provide for the fluid flow corresponding to each of the three configurations of filtration apparatus 1050.

In some embodiments, two or more filtration apparatuses described herein may be placed in parallel, which may accommodate larger flow rate and volume requirements without having to redesign the filtration apparatuses. For example, in larger scale filtration where the influent volume and flow rate is variable, a parallel system may be able to adequately account for the variability by being able to take some filtration apparatuses on- and off-line as needed.

In some embodiments, two or more filtration apparatuses described herein may be placed in series, which may allow for each apparatus to serve different filtration functions on the same influent fluid (e.g., varying pore sizes from larger to smaller, chemical filtration in series with particulate filtration, and the like).

Some embodiments of the present invention may involve filtering an influent fluid through a filter or filtration apparatus described herein (including filter or filtration apparatuses in series and/or parallel).

Fluids suitable for filtration may include liquids (e.g., comprising aqueous fluids, water, brine, river water, well water, pool water, chemically treated water, waste water, sewage, and the like) and gases (e.g., comprising air, oxygen, nitrogen, hydrogen, helium, natural gas, propane, acetylene, a stabilized fuel gas, carbon dioxide, chlorine, argon, neon, nitrous oxide, combustion engine exhaust, chemical reaction exhaust, and the like). In some instances, the filters and/or filtration apparatuses described herein may be designed for use in conjunction with pools, waste water treatment, home water treatment, grey water treatment, drinking water production, respirators, internal combustion engines, chemical plants (e.g., liquid or gas exhaust), vacuum cleaners, air compressors, home air filtration, and the like, taking into consideration material compatibility, desired flow rates, and filter and/or filtration apparatus size.

### III. Granular Filter Media

In some embodiments, the granular filter media for use in conjunction with filters and filtration apparatuses described herein may comprise buoyant granules (e.g., having a specific gravity less than about 1.0), non-buoyant (e.g., having a specific gravity ranging from about 1.00 to about 7.00), and any combination thereof. Examples of granular filter media may include, but are not limited to, fibers, thermoplastic particles, foamed particles, pumice, ion exchange resins, hollow glass beads, ceramic particles, sand, glass beads, diatomaceous earth, activated carbon, anthracite coal, slag, zeolite materials, antimicrobial particles (e.g., silver particles), and the like, any hybrid thereof, and any combination thereof. In some embodiments, the fibers may have an aspect ratio of greater than about 1. In some embodiments, the fibers may have an aspect ratio ranging from a lower limit of about 2, 5, 10, 50, or 100 to an upper limit of about 1000, 750, 500, or 100, and wherein the aspect ratio may range from any lower limit to any upper limit and encompasses any subset therebetween. In some embodiments, the fibers may have an average diameter ranging from a lower limit of about 100 nm, 1 micron, 5 microns, or 10 microns to an upper limit of about 50 microns, 25 microns, or 10 microns, and wherein the average diameter may range from any lower limit to any upper limit and encompass any range therebetween.

In some embodiments, the buoyant granular filter media may comprise at least one polymer of: polyethylene, polypropylene, polybutylene, polyethylene-co-polybutylene, polyethylene-co-polypropylene, polypropylene-co-polybutylene, and the like, and any blend thereof. In some embodiments, the non-sintered, buoyant filter media described herein comprising such polymers may advantageously be elastic particles in the filter beds that are mechanically compacted within the media body described herein are compressed to yield smaller pore sizes (e.g., as compared to sand or diatomaceous earth) for a similar average particle size and substantially rebound in shape when the compaction is released during backwashing.

In some embodiments, the polymers of the buoyant granular filter media may be a high to ultrahigh molecular weight polymer of at least one of: polyethylene, polypropylene, polybutylene, polyethylene-co-polybutylene, polyethylene-co-polypropylene, polyethylene-co-polybutylene, and the like, and any blend thereof. As used herein, the term “high to ultrahigh molecular weight polymer” should be taken to encompass high molecular weight polymer, very-high molecular weight polymer, ultrahigh molecular weight polymer, and any blend thereof. As used herein, the term “high molecular weight polymer” refers to a polymer composition having an average molecular weight of about 300,000 g/mol to about 1,000,000 g/mol. As used herein, the term “very-high molecular weight polymer” refers to a polymer composition having an average molecular weight of about 1,000,000 g/mol to about 3,000,000 g/mol. As used herein, the term “ultrahigh molecular weight polymer” refers to a polymer composition having an average molecular weight of about 3,000,000 g/mol to about 20,000,000 g/mol.

In some embodiments, the buoyant granular filter media may have a bulk density ranging from a lower limit of about 0.10 g/cm³, 0.25 g/cm³, or 0.5 g/cm³ to an upper limit of less than 1.0 g/cm³, about 0.9 g/cm³, 0.75 g/cm³, or 0.5 g/cm³, and wherein the bulk density may range from any lower limit to any upper limit and encompasses any subset therebetween (e.g., 0.10 g/cm³ to about 0.30 g/cm³).

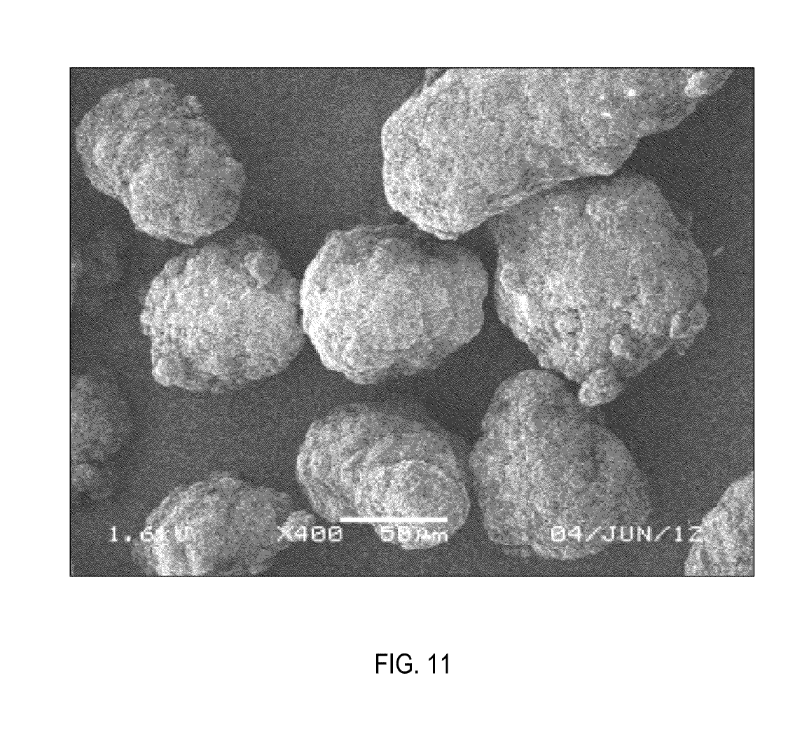

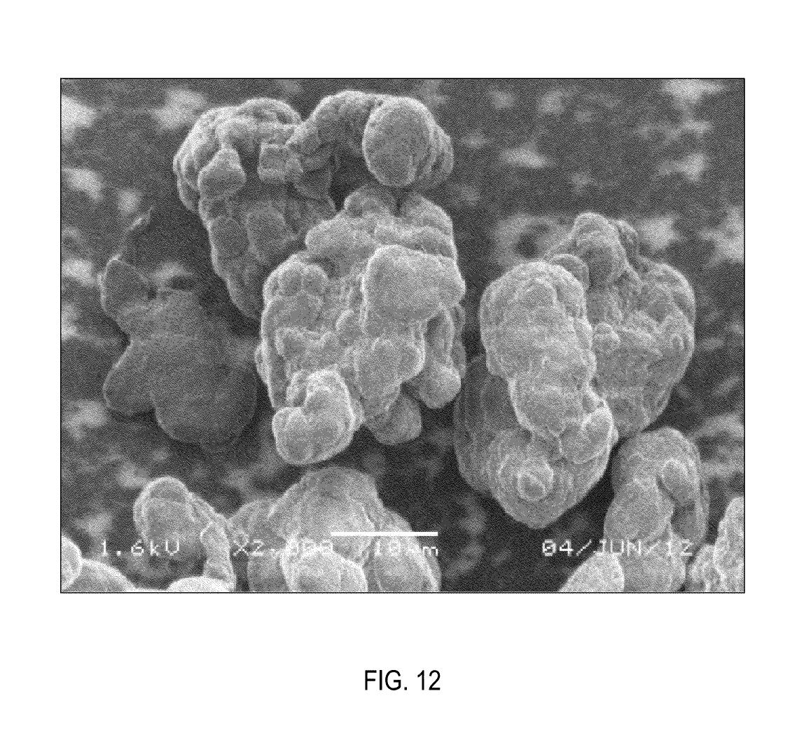

In some embodiments, the buoyant granular filter media may have a desired shape to create the desired porosity when compacted. Examples of shapes may, in some embodiments, include, but are not limited to, spherical, substantially spherical, ovular, substantially ovular, prolate, globular, potato (as shown in FIG. 11), substantially potato, popcorn, substantially popcorn, discus, platelet, flake, acicular, polygonal, randomly shaped, and any hybrid thereof. As used herein, a “popcorn” shape refers to particles that are generally spherical, ellipsoidal, prolate, or globular with a bulbous surface, e.g., as shown in FIG. 12. Popcorn-shaped buoyant granular filter media may be preferred in some embodiments.

In some embodiments, granular filter media may have an average particle size (“d₅₀”) in at least one dimension ranging from a lower limit of about 1 micron, 10 microns, 50 microns, 100 microns, 150 microns, 200 microns, and 250 microns to an upper limit of about 5000 microns, 2000 microns, 1000 microns, 750 microns, 500 microns, 400 microns, 300 microns, 250 microns, 200 microns, 150 microns, or 100 microns, and wherein the average particle size may range from any lower limit to any upper limit and encompasses any subset therebetween.

In some embodiments, the granular filter media may comprise composite particles that comprise a granule and an active agent, which may, for example, beneficially participate in the adsorption of organic contaminants from the filter fluid. As used herein, the term “composite particle” refers to a particle of two or more materials that are not miscible (e.g., not polymer blends, but rather polymers plus solid agents like graphite). Examples of active agents may, in some embodiments, include, but are not limited to, activated carbon of any activity (e.g., carbon capable of 60% CCl₄ adsorption), graphite, ion exchange resins, silicates, molecular sieves, silica gels, activated alumina, zeolites, mineral materials (e.g., perlite, sepiolite, magnesium silicate, and the like), Fuller's Earth, antimicrobial agents (e.g., silver particles), and the like, and any combination thereof. By way of nonlimiting example, the non-sintered, buoyant filter media described herein may comprise composite particles that comprise ultrahigh molecular weight polyethylene and activated carbon.

It should be noted that granular filter media designed to adsorb organic components, e.g., some composite particles and other particles like diatomaceous earth and activated carbon, may strongly bind to the organic components. As such, backwash may remove only some of the organic components therefrom. Accordingly, in some embodiments, backwash cycles may be augmented with the addition of a chemical (e.g., a bleach, an acid, ozone, or the like) or elevated temperature (e.g., backwashing with a hot fluid) that facilitate desorption of the organic components so as to more effectively regenerate the granular filter media.

In some embodiments, the granular filter media may have an anti-fouling surface modifier disposed on at least a portion of the surfaces of the granules. The anti-fouling surface modifier may, in some embodiments, be physically bound and/or chemically bound to the surface of the non-sintered, buoyant filter media described herein. Examples of anti-fouling surface modifiers that may include, but are not limited to, siloxanes, polymerized siloxanes, siloxane-based copolymers, polydimethylsiloxane, fluorochemicals, fluoropolymers, fluorocopolymers, polytetrafluoroethylene, polyvinylfluoride, polyvinylidiene fluoride, polychlorotrifluoroethylene, perfluoroalkoxy polymers, fluorinated ethylene-propylene, polyethylenetetrafluoroethylene, polyethylenechlorotrifluoroethylene, perfluoropolyether, polyethylene oxide, polyethylene glycols, polyvinyl pyrrolidone, polyacrylates, and the like, and any combination thereof.

In some embodiments, the granular filter media may comprise two or more types of granules as differentiated by at least one of bulk density, shape, size, composition, surface modification, inclusion of an active agent, and any combination thereof. In some embodiments, the two or more types of filter media may form a striated filter bed based on the specific gravity and/or bulk density of the filter media. For example, granular filter media may comprise a plurality of first granules having a bulk density of about 0.35 g/cm³ to about 0.9 g/cm³ and a plurality of second granules having a bulk density of about 0.1 g/cm3 to about 0.3 g/cm³. In another example, granular filter media may comprise a plurality of first granules having a bulk density of about 0.35 g/cm³ to about 0.9 g/cm³, a plurality of second granules having a bulk density of about 0.1 g/cm³ to about 0.3 g/cm³, and a plurality of third granules having a bulk density of greater than about 1.2 g/cm³ (e.g., about 1.2 g/cm³ to about 3.0 g/cm³). Without being limited by theory, it is believed that because the differences in bulk density may be designed such that after backwashing the granules may settle back into a striated filter bed. In yet another example, granular filter media may comprise a plurality of first granules that are popcorn-shaped having a first average particle size and a plurality of second granules that are popcorn-shaped having a second average particle size that is different than the first average particle size (e.g., by at least 10% to as much as 95%, including any subset thereof) with the first and second granules having similar bulk densities (e.g., about 0.1 g/cm³ to about 0.3 g/cm³), so as to provide for a single striation, and the granular filter media may further comprise a plurality of third granules having a bulk density of greater than the bulk density of the first and second granules (e.g., about 0.5 g/cm³ or greater), so as to provide for a second striation. One of ordinary skill in the art with the benefit of this disclosure should understand that striations may not be clearly defined (i.e., mixed) at the interface between the striated volumes that substantially comprise the granular filter media of a given bulk density.

In some embodiments, the bulk density of the granular filter media may be used in combination with particle size so as to yield a striated filter bed with each striation having a desired porosity. For example, granular filter media may comprise a plurality of first granules having a bulk density of about 0.35 g/cm³ to about 0.9 g/cm³ and a particle size of about 30 microns to about 75 microns and a plurality of second granules having a bulk density of about 0.1 g/cm³ to about 0.3 g/cm³ with a particle size of about 100 microns to about 250 microns.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A filtration apparatus comprising:
a filtration apparatus inlet;
a filtration apparatus outlet;
first and second filters each being independently movable between a filtration configuration and a backwash configuration and each comprising:
a filter inlet, a filter outlet, a backwash inlet, a backwash outlet, and a media body that comprises a top and a bottom and containing a granular filter media, the media body being movable between a compacted state in the filtration configuration and an expanded state in the backwash configuration, the media body being disposed between the filter inlet and the filter outlet, and the media body being disposed between the backwash inlet and the backwash outlet;
a valve apparatus being movable between at least three positions that comprise:
a dual filtration position that provides for the first filter in the filtration configuration and the second filter in the filtration configuration with the filtration inlet being in fluid communication with the first filter inlet and the second filter inlet, and the filtration apparatus outlet being in fluid communication with the first filter outlet and the second filter outlet,
a first filter backwash position that provides for the first filter in the backwash configuration and the second filter in the filtration configuration with the filtration inlet being in fluid communication with the second filter inlet, and the second filter outlet being in fluid communication with the first backwash inlet and the filtration apparatus outlet, and
a second filter backwash position that provides for the first filter in the filtration configuration and the second filter in the backwash configuration with the filtration inlet being in fluid communication with the first filter inlet, and the first filter outlet being in fluid communication with the second backwash inlet and the filtration apparatus outlet.

2. The filtration apparatus of claim 1, wherein the filter inlet is the backwash outlet.

3. The filtration apparatus of claim 1, wherein the filter outlet is the backwash inlet.

4. The filtration apparatus of claim 1, wherein the valve apparatus comprises a cam, a first pushrod operably connected to the first filter, and a second pushrod operably connected to the second filter capable of transitioning the first and second filters between filtration configuration and backwash configuration that correspond to the three positions of the valve apparatus.

5. The filtration apparatus of claim 1, wherein at least one of the first and second tops have a hemi-orbicular shape.

6. The filtration apparatus of claim 1, wherein at least one of the first and second tops have a substructure.

7. The filtration apparatus of claim 1, wherein at least one of the first and second media bodies provide for a variable depth filter bed comprising the granular filter media when the media body is in the compacted state.

8. The filtration apparatus of claim 1, wherein at least one of the first and second filters comprise at least one port configured to provide for flow fluid tangential to the top while in the filtration configuration.

9. The filtration apparatus of claim 1, wherein at least one of the first and second filters comprise at least one port configured to provide for flow fluid tangential to the top while in the backwash configuration.

10. The filtration apparatus of claim 1, wherein at least one of the first and second filters comprise at least one port configured to provide for flow fluid tangential to the bottom while in the backwash configuration.

11. The filtration apparatus of claim 1, wherein the granular filter media comprises buoyant granules.

12. A filter having a filtration configuration and a backwash configuration, the filter comprising:
a housing;
a filter inlet;
a filter outlet;
a backwash inlet;
a media body that comprises a top and a bottom and containing a granular filter media, the media body being movable between a compacted state in the filtration configuration and an expanded state in the backwash configuration, the media body being disposed between the filter inlet and the filter outlet, and the media body being disposed between the backwash inlet and the backwash outlet; and
at least one port configured to provide for flow fluid at an angle deviated from a filtration flow direction and a backwash flow direction, the filtration flow direction being from the filter inlet through the media body to the filter outlet, and the backwash flow direction being from the backwash inlet through the media body to the backwash outlet.

13. The filter of claim 12, wherein the at least one port is configured to provide for flow fluid tangential to the top while in the filtration configuration.

14. The filter of claim 12, wherein the at least one port configured to provide for flow fluid tangential to the top while in the backwash configuration.

15. The filter of claim 12, wherein the at least one port configured to provide for flow fluid tangential to the bottom while in the backwash configuration.

16. The filter of claim 12, wherein the filter has a variable filter bed depth.

17. A filtration apparatus comprising a first filter according to claim 12 and a second filter.

18. A filter having a filtration configuration and a backwash configuration, the filter comprising:
a housing;
a filter inlet;
a filter outlet;
a backwash inlet;
a backwash outlet;
a media body that comprises a top and a bottom and containing a granular filter media, the media body being movable between a compacted state in the filtration configuration and an expanded state in the backwash configuration, the media body being disposed between the filter inlet and the filter outlet, and the media body being disposed between the backwash inlet and the backwash outlet; and
wherein the top and the bottom independently have a substructure to provide for a variable depth filter bed comprising the granular filter media when the media body is in the compacted state.

19. A filtration apparatus comprising a first filter according to claim 18 and a second filter.

20. A filter having a filtration configuration and a backwash configuration, the filter comprising:
a housing;
a filter inlet;
a filter outlet;
a backwash inlet;
a backwash outlet;
a media body that comprises a top and a bottom and containing a granular filter media, the media body being movable between a compacted state in the filtration configuration and an expanded state in the backwash configuration, the media body being disposed between the filter inlet and the filter outlet, and the media body being disposed between the backwash inlet and the backwash outlet; and
wherein at least one of the first and second tops have a hemi-orbicular shape.
